(19) United States
(12) Patent Application Publication
(10) Pub. No.: US 2020/0134606 A1
(43) Pub. Date: Apr. 30, 2020

(54) ASSET MANAGEMENT IN ASSET-BASED BLOCKCHAIN SYSTEM

(71) Applicant: EMC IP Holding Company LLC, Hopkinton, MA (US)

(72) Inventors: Stephen J. Todd, Center Conway, NH (US); Assaf Natanzon, Tel Aviv (IL)

(21) Appl. No.: 16/176,595

(22) Filed: Oct. 31, 2018

(51) Int. Cl. G06Q 20/36; G06Q 20/38

(52) U.S. Cl. CPC G06Q 20/3676; G06Q 20/065; G06Q 2220/00; G06Q 20/389

(57) ABSTRACT

Techniques for improved asset management in an asset-based distributed ledger such as a blockchain system are disclosed. In one method, an asset balance structure is obtained, wherein the asset balance structure specifies asset balances, as of a given point in time, for a set of blockchain addresses associated with a blockchain system comprising blocks that reflect transactions associated with the assets. One or more transactions associated with the assets for any of the set of blockchain addresses that occur after generation of the asset balance structure are obtained. The one or more transactions associated with the assets that occur after generation of the asset balance structure are applied to the asset balance structure to generate an updated indication of the asset balances for the set of blockchain addresses. Advantageously, a given asset wallet stores the asset balance structure rather than the entire set of blocks of the blockchain system.

### FIELD

The field relates generally to data management, and more particularly to techniques for data management in distributed ledgers.

### BACKGROUND

Blockchain is a computational technology used to create a distributed ledger. In many cases, ledgers are used to describe ownership and transactions on assets. One example of an asset-based blockchain system is a bitcoin system first described in Satoshi Nakamoto, “Bitcoin: A Peer to Peer Electronic Cash System,” 2008, the disclosure of which is incorporated by reference herein in its entirety. In a bitcoin system, the asset is a virtual coin or cryptocurrency, called a bitcoin, and the ledger contains a list of transactions which include creation of new bitcoins, and transfer of bitcoins or portions of a bitcoin (satoshis) to other bitcoin users. A satoshi (named after the author of the above-referenced paper) is the smallest divisible denomination of a bitcoin, i.e., one satoshi is equivalent to one hundred millionth of one bitcoin.

The cryptocurrency value owned by a bitcoin user is kept track of in a bitcoin wallet. A bitcoin wallet is the name given to the software program that manages the bitcoin balance of a user. One of the most difficult challenges is that a bitcoin wallet includes the entire ledger; which requires a large amount of storage.

### SUMMARY

Illustrative embodiments of the invention provide techniques for improved asset management in an asset-based distributed ledger such as a blockchain system.

For example, in an illustrative embodiment, a method comprises the following steps. An asset balance structure is obtained, wherein the asset balance structure specifies asset balances, as of a given point in time, for a set of blockchain addresses associated with a blockchain system comprising blocks that reflect transactions associated with the assets. One or more transactions associated with the assets for any of the set of blockchain addresses that occur after generation of the asset balance structure are obtained. The one or more transactions associated with the assets that occur after generation of the asset balance structure are applied to the asset balance structure to generate an updated indication of the asset balances for the set of blockchain addresses.

For example, the set of blockchain addresses correspond to asset wallets of users of the blockchain system. A given asset wallet stores the asset balance structure rather than the entire set of blocks of the blockchain system. The asset balance structure, when generated, comprises one or more outputs of transactions that do not serve as one or more inputs to any subsequent transactions. The asset balance structure is stored as a snapshot.

Advantageously, illustrative embodiments generate an asset balance structure for asset wallets associated with the asset-based blockchain, and determine updated asset value for a user based on the structure and any relevant transactions that occurred subsequent to the structure creation. As such, the storage overhead needed by a computing device that holds an asset wallet is greatly reduced so as to improve computational operation of the computing device and the computing network in which it operates.

These and other features and advantages of the invention will become more readily apparent from the accompanying drawings and the following detailed description.

### BRIEF DESCRIPTION OF THE DRAWINGS

FIG. 1 illustrates a blockchain system with which one or more illustrative embodiments are implemented.

FIG. 2A illustrates an example format of a bitcoin transaction inside of a block.

FIG. 2B illustrates an example of bitcoin transaction data with one input and one output.

FIG. 3 illustrates an example flow of an asset through a blockchain.

FIG. 4 illustrates an asset balance structure for use in an asset-based blockchain system according to an illustrative embodiment of the invention.

FIG. 5 illustrates a methodology for managing assets in an asset-based blockchain system using an asset balance structure according to an illustrative embodiment.

FIG. 6 illustrates a processing platform used to implement an asset-based blockchain system with one or more asset balance structures according to an illustrative embodiment.

### DETAILED DESCRIPTION

Illustrative embodiments will be described herein with reference to exemplary information processing systems and associated host devices, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual computing resources. An information processing system may therefore comprise, for example, a cloud infrastructure hosting multiple tenants that share cloud computing resources. Such systems are considered examples of what are more generally referred to herein as cloud computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or an computing system. On the other hand, cloud infrastructures that are used by multiple enterprises, and not necessarily controlled or managed by any of the multiple enterprises but rather are respectively controlled and managed by third-party cloud providers, are typically considered “public clouds.” Thus, enterprises can choose to host their applications or services on private clouds, public clouds, and/or a combination of private and public clouds (hybrid clouds).

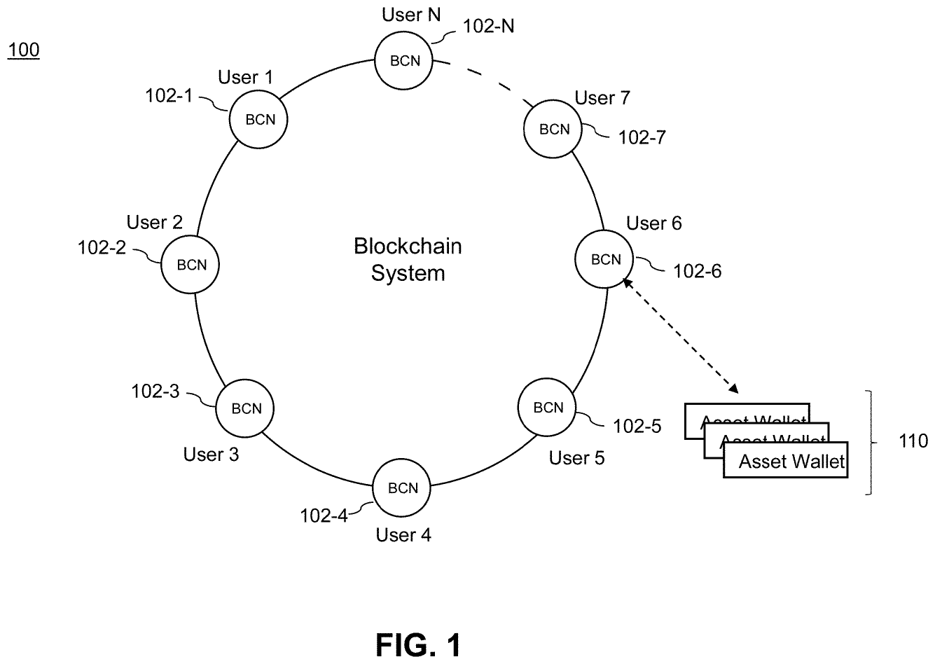

Before describing illustrative embodiments, details of a blockchain system with which one or more embodiments may be implemented will be described in the context of FIG. 1. More particularly, FIG. 1 illustrates a blockchain system 100, according to an illustrative embodiment. As generally illustrated, a plurality of blockchain nodes (BCNs), labeled 102-1, 102-2, 102-3, 102-4, 102-5, 102-6, 102-7, . . . , 102-N, are operatively coupled to form a distributed ledger system. Each BCN has a user associated therewith, i.e., User 1, User 2, User 3, User 4, User 5, User 6, User 7, . . . , User N. More than one user may be associated with a single BCN, and more than one BCN can be associated with a single user.

As used herein, the terms “blockchain,” “chain,” “distributed ledger,” and ““ledger” may be used interchangeably. As is known, the blockchain protocol is implemented via a distributed, decentralized computer network of compute nodes (e.g., BCNs 102-1, 102-2, 102-3, 102-4, 102-5, 102-6, 102-7, . . . , 102-N). The compute nodes are operatively coupled in a peer-to-peer communications protocol (e.g., as illustratively depicted as system 100 in in FIG. 1). In the computer network, each compute node is configured to maintain a blockchain which is a cryptographically secured record or ledger of data blocks that represent respective transactions within a given computational environment. The blockchain is secured through use of a cryptographic function, e.g., a hash function. A hash function is a cryptographic function which takes an input (or “message”) and returns a fixed-size alphanumeric string, which is called the hash value (also a message digest, a digital fingerprint, a digest, or a checksum). Other cryptographic functions can be employed.

Each blockchain is thus a growing list of data records (i.e., blocks) hardened against tampering and revision. Each block may typically include data for multiple transactions (e.g., current transaction and previous transactions) and a link to a previous block. Thus, advantageously, each data block in the blockchain represents a given set of transaction data plus a set of all previous transaction data.

A key principle of the blockchain is that it is trusted. That is, it is critical to know that data in the blockchain has not been tampered with by any of the compute nodes in the computer network (or any other node or party). For this reason, a hash function is used. While such a hash function is relatively easy to compute for a large data set, each resulting hash value is unique such that if one item of data in the blockchain is altered, the hash value changes. However, it is realized that given the constant generation of new transactions and the need for large scale computation of hash values to add the new transactions to the blockchain, the blockchain protocol rewards compute nodes that provide the computational service of calculating a new hash value. In the case of a bitcoin network, a predetermined number of bitcoins are awarded for a predetermined amount of computation. The compute nodes thus compete for bitcoins by performing computations to generate a hash value that satisfies the blockchain protocol. Such compute nodes are referred to as “miners.” Performance of the computation of a hash value that satisfies the blockchain protocol is called “proof of work.” While bitcoins are one type of reward, blockchain protocols can award other measures of value (monetary or otherwise) to successful miners.

As mentioned above, bitcoins owned by a given user are maintained by a bitcoin wallet. Each BCN in FIG. 1 may have one or more bitcoin wallets. By way of example, one or more asset (bitcoin) wallets 110 are shown for BCN 102-6, although it is to be understood that each BCN in FIG. 1 has one or more asset wallets 110 associated therewith but are not otherwise shown for the sake of simplifying the illustration. For example, a given user may have a different bitcoin wallet for each ledger application type (e.g., personal bitcoin account, business bitcoin account, etc.). Alternatively, a BCN may have a different wallet for each user or group of users associated therewith.

Further, it is to be appreciated that blockchain protocols, bitcoin or otherwise, may form a consensus network whereby a transaction is only added to the blockchain when validated by a consensus of BCNs 102-1, 102-2, 102-3, 102-4, 102-5, 102-6, 102-7, . . . , 102-N. That is, if consensus is reached, then each BCN adds the new block to the blockchain they currently maintain. As a result, after a new transaction is processed by the system 100, each BCN should now have a copy of the same updated blockchain stored in its memory. Then, when a new transaction comes into the system 100, the consensus process is repeated.

It is to be appreciated that the above descriptions represent illustrative implementations of blockchain and consensus protocols and that embodiments of the invention are not limited to the above or any particular blockchain or consensus protocol implementation. As such, other appropriate processes may be used to securely maintain and add to a set of data in accordance with embodiments of the invention. For example, distributed ledgers such as, but not limited to, R3 Corda, Ethereum, and Hyperledger may be employed in illustrative embodiments.

While a bitcoin system is used as an example of an asset-based blockchain system for purposes of the illustrative description, it is to be appreciated that embodiments are not limited to a bitcoin system.

A bitcoin transaction is a transfer of bitcoin value that is broadcast to the network and collected into blocks. A transaction typically references previous transaction outputs as new transaction inputs and dedicates all input bitcoin values to new outputs. All transactions are visible in the blockchain, typically using a blockchain browser whereby every transaction can be viewed in human-readable terms.

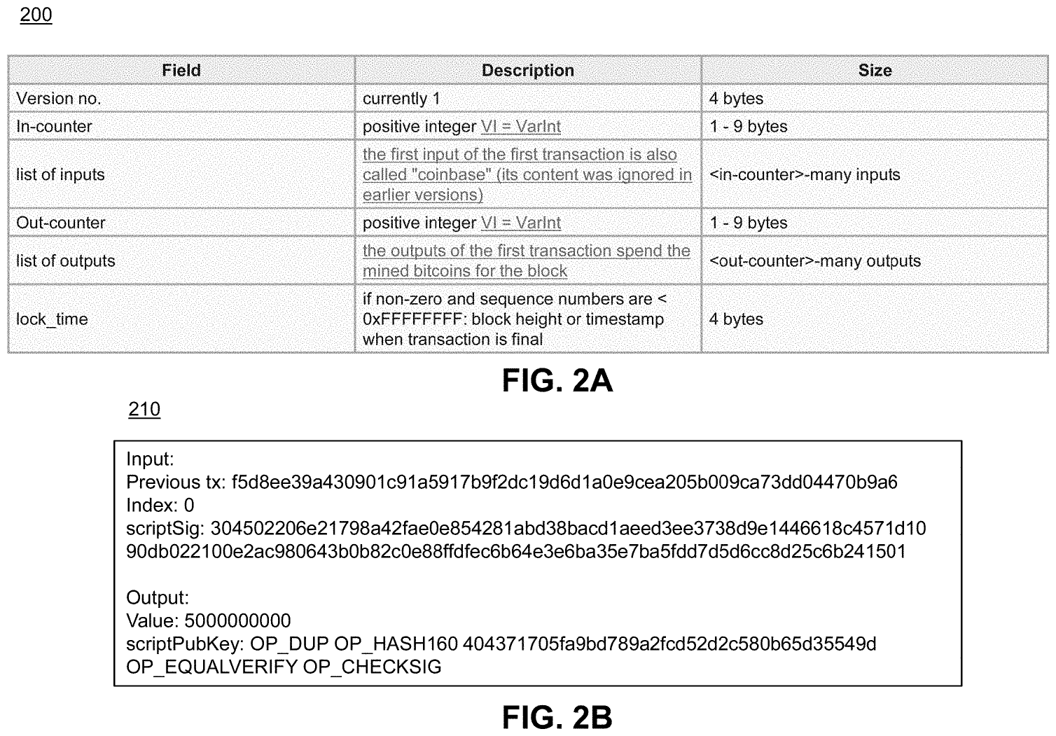

FIG. 2A illustrates an example format 200 of a bitcoin transaction inside a block with which one or more illustrative embodiments are implemented. FIG. 2B illustrates an example 210 of bitcoin transaction data with one input and one output. These non-limiting examples are for illustration purposes only and are further described at Bitcoin Wiki (https://en.bitcoin.it/wiki/Transaction).

For example, the input in this transaction imports a given number of bitcoins (e.g., 50 bitcoins) from a given output (e.g., output #0) in a given transaction. Then, the given number of bitcoins is sent to a bitcoin address. When the recipient wants to spend this cryptocurrency, he will reference the given output (e.g., output #0) of this transaction in an input of his own transaction.

Thus, an input is a reference to an output from a previous transaction. Multiple inputs are often listed in a transaction. All input values of the new transactions (that is, the total coin value of the previous outputs referenced by the inputs of the new transactions) are added up, and the total (less any transaction fee) is completely used by the outputs of the new transaction. ‘Previous tx’ in FIG. 2B is a hash of a previous transaction. ‘Index’ is the specific output in the referenced transaction. ‘ScriptSig’ is the first half of a script.

The script contains two components including a signature and a public key. The public key must match the hash given in the script of the redeemed output. The public key is used to verify signature of the redeemer, which is the second component. More particularly, the second component is an elliptical curve digital signature algorithm (ECDSA) signature over a hash of a simplified version of the transaction. The ECDSA signature, combined with the public key, proves the transaction was created by the real owner of the address in question.

An output contains instructions for sending bitcoins. ‘Value’ is the number of satoshis that this output will be worth when claimed. ‘ScriptPubKey’ is the second half of a script. There can be more than one output, and they share the combined value of the inputs. Because each output from one transaction can only ever be referenced once by an input of a subsequent transaction, the entire combined input value needs to be sent in an output in order to avoid losing input value. For example, if the input is worth 50 bitcoins but a given user only wants to send 25 bitcoins, the bitcoin system creates two outputs worth 25 bitcoins: one to the destination, and one back to the given user (referred to as “change”). Any input bitcoins not redeemed in an output are considered a transaction fee.

Accordingly, it is realized that important information to perform a transaction is the output of a previous transaction showing that a given user is the owner of certain bitcoins. Each output can be used as input for a new transaction. But only the outputs which are not inputs to other transactions are important for new transactions. The bitcoin history is therefore used to prove that the output transactions are indeed genuine and were not used again since.

A blockchain keeps all historical transactions and, as mentioned above, a bitcoin wallet needs to download all historical transactions, which means a wallet (110 in FIG. 1) can require in the case of bitcoin up to 80 GB (and growing) of storage space.

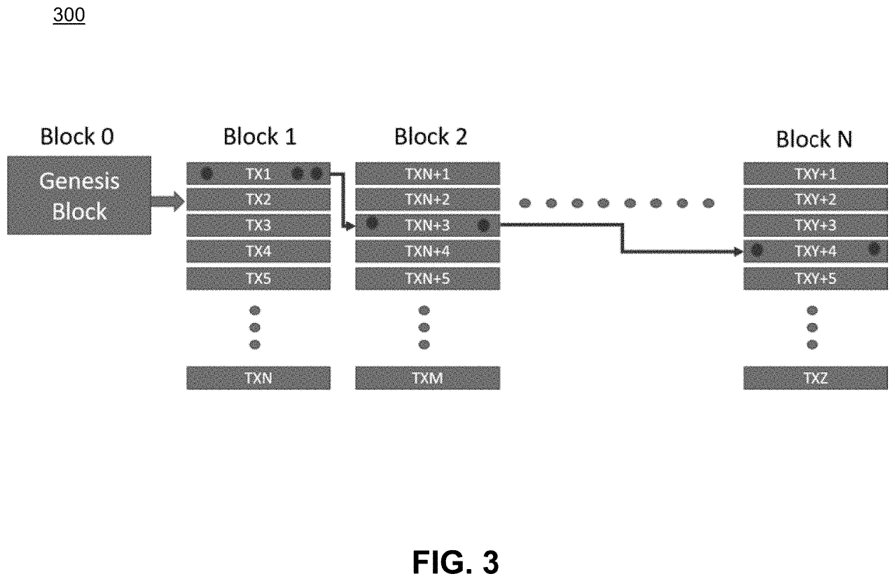

FIG. 3 illustrates a blockchain 300 and depicts how one asset flows between a subset of all the transactions in the ledger. In this example, operations transfer (denoted by the arrows) one bitcoin (denoted by black dot) from one user to another. The setup of the asset wallet, and the initialization of the ledger, can cause a significant number of problems, some of which will now be described.

Blockchain Ledger Requires Downloading all Transactions.

The current approach requires a long boot time to download the entire ledger to the asset wallet (110 in FIG. 1) of a blockchain node. This becomes increasingly problematic as the ledger continues to grow longer and longer (e.g., the value “N” continually increases for “Block N” in FIG. 3). Long wait times may occur on every boot as blockchain applications wait for the ledger to fully initialize.

Blockchain Ledger Requires Storing all Transactions.

The history of a blockchain asset (e.g., a bitcoin) is important for validation of new spending. For those users with wallets that do not necessarily wish to store the entire blockchain for validation, what is important (as realized by embodiments described herein) is who currently owns each portion of a bitcoin and not necessarily the history of each bitcoin. This is especially problematic for devices that may have restricted storage capacities.

Current Balance Calculation.

For an application to discover the current balances of all users (or specific users), the application must start at the genesis block (first block as shown in FIG. 3) and iterate through every single block (and transaction) in the entire ledger. This is not only time-consuming but CPU- and memory-consuming as well (especially for small devices with limited memory footprints.

Single-Owner Assets.

In asset-based ledgers, the fact that there are assets with a single owner is not represented in the data format. Thus, an asset that moves many times will be represented many times in the ledger. For example, if there is a bitcoin that moves between 1000 wallets, it will be represented 1000 times in the ledger. Since transactions can break bitcoins into satoshis and unite bitcoins and satoshis into a new asset, it means that the graph of transactions can be very deep and thus a single output can represent a chain of any length of transactions that needs to be verified.

Indefinite (or Infinite) Growth of Ledgers.

The fact that these ledgers grow indefinitely means that: (a) local resources will continually be consumed more and more; and (b) algorithms or applications that require iteration over the ledger will grow in their complexity, runtime length, and consumption of resources.

Illustrative embodiments address the above and other drawbacks associated with an asset-based blockchain system such as, for example, a bitcoin system, by generating and using an asset balance structure for asset wallets to track the transfer of assets. The asset balance structure, in one or more illustrative embodiments, utilizes a continuous data protection (CDP) approach.

In CDP, there is typically a given storage volume containing the given volume state and a journal containing recent transactions (not reflected in the given volume state). The CDP journal is used to generate a representation of the storage volume at any point in time by applying the transactions to the given storage volume. For example, one CDP technique is to maintain a snapshot of the storage at multiple points in time as well as the journal. A snapshot is a copy of a storage volume at a specific time instance. A snapshot typically contains the full directory structure of the volume. Snapshots can be used as incremental backups of storage volumes, as restore points for data, as long-term storage for data, or as starting points for new storage volumes. Thus, if a storage volume at a particular time instance is desired, the volume can be obtained by starting with the latest (most recent) snapshot before the requested time instance and applying the data from the journal until the volume represents the status at the requested time instance. So, for example, assume a snapshot of a storage volume exists for time t1. Then, to get an updated copy of the storage volume at time t2, the snapshot is updated with all data transactions from the journal that occurred immediately after time t1 up until time t2. The journal and the snapshot are effectively coalesced.

Illustrative embodiments consider asset-based blockchains, such as bitcoin, as storage. For example, illustrative embodiments treat each final output of a transaction (i.e., by “final” here it is meant that an output is not an input to another transaction) as a storage address, and treat the historical blockchain as a journal. More particularly, the methodology inspects the ledger at a point in time and keeps only outputs which are not inputs to other transactions. The structure that results from this inspection is referred to herein as an “asset balance structure.” Each output contains some amount of assets, e.g., satoshis, which do not necessary originate from the same bitcoin. For example, the amount can be more than a bitcoin, e.g., a user transfers 50 bitcoins to one output. Regardless of the specific asset value, the access balance structure reflects verified current balances for given addresses (asset wallets) at a given point in time. By verified, it is meant that the asset balance structure operation goes through the history of each asset (via the historical ledger that includes the full set of blocks in the blockchain) to verify that each asset is in fact properly owned by the user that purports to own it.

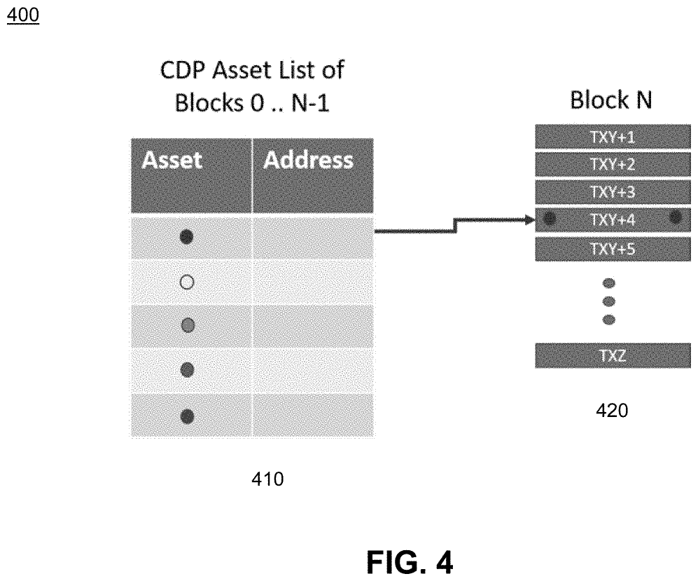

FIG. 4 illustrates an asset balance structure approach for an asset-based blockchain system according to an illustrative embodiment of the invention. As will be explained, illustrative embodiments replace the historical ledger with a snapshot of asset balances. More particularly, a CDP assets list 410 of blocks 0 through N−1 is shown with all final outputs. That is, CDP assets list is an asset balance structure that reflects addresses of asset wallets and their balances (assets such as bitcoin/satoshi values) at a given point in time.

It is contemplated that an asset balance structure is periodically generated by one or more asset wallets of BCNs (102-1 through 102-N in FIG. 1) and is accessible by a given asset wallet during initialization (e.g., booting) or update of the given BCN. The asset balance structure (410 in FIG. 4) is created by inspecting the full historical blockchain to confirm the current balance associated with each asset wallet as of a given time instance. This is done by identifying only transaction outputs which are not inputs to other transactions, i.e., the last verified transaction associated with the asset is captured for the given time instance. A snapshot is taken of this asset balance structure.

Advantageously, with the asset balance structure and knowledge of any transactions associated with a given asset reflected in the structure that have occurred since its creation, an updated asset balance is computed for a given asset wallet.

For example, as shown in block 420 in FIG. 4, assume that an asset associated with the first asset wallet address in the structure 410 (created for blocks 0 to N−1) points to a transaction (TXY+4) in block N. This reflects a transaction (TXY+4) for that asset subsequent to the creation of structure 410. Thus, an asset wallet can obtain the latest asset balance for one or more other asset wallets by updating the asset balance structure 410 with the latest transaction data 420. In this way, one user can verify the ownership of bitcoins in an asset wallet of another user in a storage-efficient manner.

It is to be appreciated that in some embodiments, each asset wallet generates its own asset balance structure and shares it with the other asset wallets in the blockchain system. In other embodiments, a single access balance structure is generated that reflects some or all of the asset wallets in the blockchain system.

This snapshot and update approach (referred to herein as a CDP approach) has many advantageous features including, for example, the following features.

Periodic Building of Snapshots.

Periodically, one or more BCNs (asset wallets) build a current snapshot. For example, every week, all transactions are consolidated and an asset balance structure such as 410 in FIG. 4 is created. Subsequent to the creation of such a snapshot, the latest transaction information is stored. The snapshot and latest transactions that have occurred since the snapshot creation gives an updated asset balance for asset wallets in the system.

Creation of New Transactions Using Snapshot+Subsequent

The snapshot, along with all transactions that happened after the snapshot, allows creation of new transactions, since all that is needed for creation of a transaction input is the output of previous transaction (see description of a bitcoin transaction above).

Flexible Storage Location of Snapshot

The snapshot does not have to be part of the blockchain and can be kept in any cloud storage. For example, in one or more illustrative embodiments, the blockchain stores the signature of the current snapshot data in one of the blocks after the snapshot is created. Then, an asset wallet can simply download the signature from the blockchain and separately download the snapshot from cloud storage.

Fast Wallet Creation Via Snapshot Download

An asset wallet downloading the snapshot confirms it has the correct content by verifying the snapshot content with the signature.

Significantly Faster Wallet Initialization (and Smaller Wallets)

A asset wallet simply downloads the last snapshot and the ledger with only the blocks after the snapshot was created, allowing significantly smaller wallets.

The snapshot only includes, for every bitcoin user which has coins in the asset wallet, the list of transaction outputs which transferred coins to the user.

Significantly Faster Balance Calculations

An application calculating the balances of assets needs only to use the CDP structure 410 (snapshot) and factor in any additional transactions since that point-in-time copy. This results in much faster application execution with far fewer resources consumed.

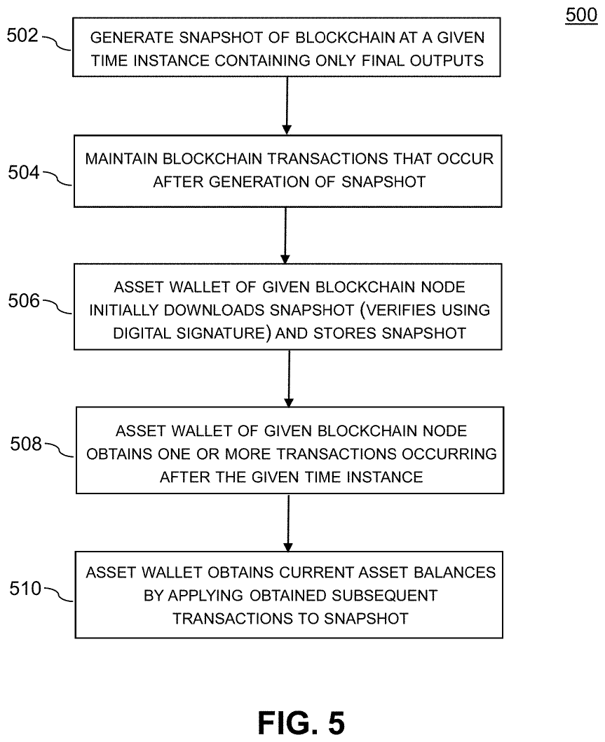

Given the illustrative description of techniques described herein, methodology 500 in FIG. 5 comprises the following steps.

In step 502, an asset balance structure (e.g., CDP structure 410) containing only final outputs (i.e., outputs that do not serve as inputs to any subsequent transactions) is generated as a snapshot at a given time instance.

In step 504, blockchain transactions that occur after generation of the snapshot in step 502 are maintained.

In step 506, an asset wallet of a given blockchain node downloads the generated snapshot (verifies using digital signature) and stores snapshot.

In step 508, the asset wallet of the given blockchain node obtains one or more transactions occurring after the given time instance (maintained in step 504).

In step 510, the asset wallet obtains the current asset balances by applying the obtained subsequent transactions to the snapshot.

At least portions of the asset-based blockchain system described herein may be implemented using one or more processing platforms associated with one or more information processing systems. In some embodiments, a given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one. In many embodiments, logic may be executed across one or more physical or virtual processors. In certain embodiments, a virtual processor may be mapped to and executed on or across a portion of one or more virtual or physical processors.

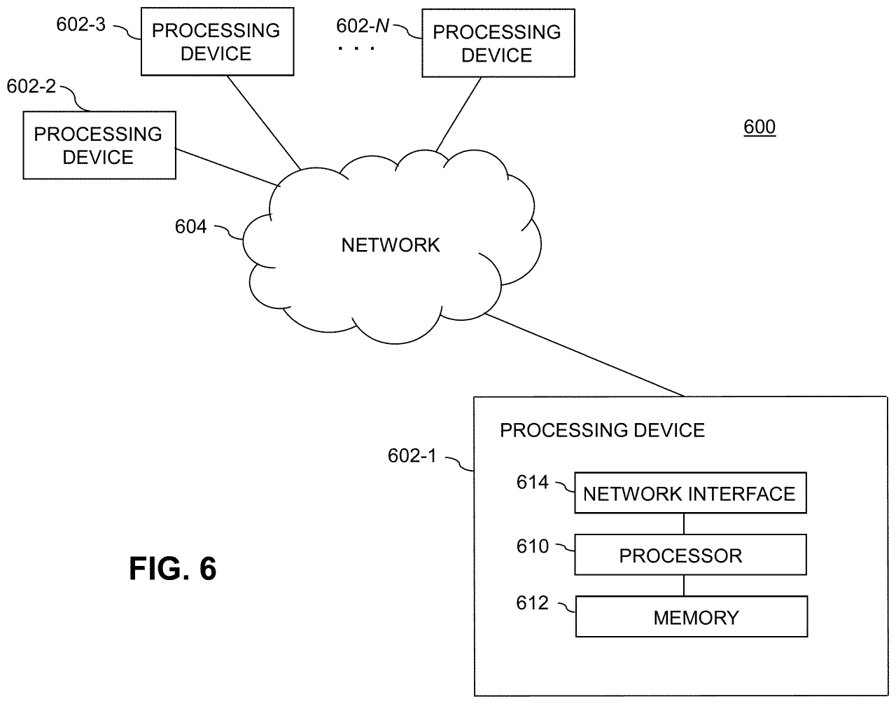

As is apparent from the above, one or more of the processing modules or other components of the system shown in FIGS. 1-5 may each run on a computer, server, storage device or other processing platform element. A given such element may be viewed as an example of what is more generally referred to herein as a “processing device.” An example of such a processing platform is processing platform 600 shown in FIG. 6.

The processing platform 600 in this embodiment comprises a plurality of processing devices, denoted 602-1, 602-2, 602-3, . . . , 602-N, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

Some networks utilized in a given embodiment may comprise high-speed local networks in which associated processing devices communicate with one another utilizing Peripheral Component Interconnect Express (PCIe) cards of those devices, and networking protocols such as InfiniBand, Gigabit Ethernet or Fibre Channel.

The processing device 602-1 in the processing platform 600 comprises a processor 610 coupled to a memory 612.

The processor 610 may comprise a microprocessor, a microcontroller, an application-specific integrated circuit (ASIC), a field-programmable gate array (FPGA) or other type of processing circuitry, as well as portions or combinations of such circuitry elements.

The memory 612 may comprise random access memory (RAM), read-only memory (ROM) or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered embodiments of the present disclosure. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 of the example embodiment of FIG. 6 is network interface circuitry 614, which is used to interface the processing device with the network 604 and other system components and may comprise conventional transceivers.

The other processing devices 602 of the processing platform 600 are assumed to be configured in a manner similar to that shown for processing device 602-1 in the figure.

Again, this particular processing platform is presented by way of example only, and other embodiments may include additional or alternative processing platforms, as well as numerous distinct processing platforms in any combination, with each such platform comprising one or more computers, servers, storage devices or other processing devices.

For example, other processing platforms used to implement embodiments of the disclosure can comprise different types of virtualization infrastructure, in place of or in addition to virtualization infrastructure comprising virtual machines. Such virtualization infrastructure illustratively includes container-based virtualization infrastructure configured to provide Docker containers or other types of Linux containers (LXCs).

The containers may be associated with respective tenants of a multi-tenant environment, although in other embodiments a given tenant can have multiple containers. The containers may be utilized to implement a variety of different types of functionality within the system. For example, containers can be used to implement respective cloud compute nodes or cloud storage nodes of a cloud computing and storage system. The compute nodes or storage nodes may be associated with respective cloud tenants of a multi-tenant environment. Containers may be used in combination with other virtualization infrastructure such as virtual machines implemented using a hypervisor.

As another example, portions of a given processing platform in some embodiments can comprise converged infrastructure such as VxRail™, VxRack™ or Vblock® converged infrastructure commercially available from VCE, the Virtual Computing Environment Company, now the Converged Platform and Solutions Division of Dell EMC. For example, portions of a system of the type disclosed herein can be implemented utilizing converged infrastructure.

It should therefore be understood that in other embodiments different arrangements of additional or alternative elements may be used. In many embodiments, at least a subset of these elements may be collectively implemented on a common processing platform, or each such element may be implemented on a separate processing platform.

Also, in other embodiments, numerous other arrangements of computers, servers, storage devices or other components are possible. Such components can communicate with other elements of the system over any type of network or other communication media.

As indicated previously, in some embodiments, components of the system as disclosed herein can be implemented at least in part in the form of one or more software programs stored in memory and executed by a processor of a processing device. For example, at least portions of the execution environment or other system components are illustratively implemented in one or more embodiments the form of software running on a processing platform comprising one or more processing devices.

It should again be emphasized that the above-described embodiments of the disclosure are presented for purposes of illustration only. Many variations and other alternative embodiments may be used. For example, the disclosed techniques are applicable to a wide variety of other types of systems. Also, the particular configurations of system and device elements, associated processing operations and other functionality illustrated in the drawings can be varied in other embodiments. Moreover, the various assumptions made above in the course of describing the illustrative embodiments should also be viewed as exemplary rather than as requirements or limitations of the embodiments. Numerous other alternative embodiments within the scope of the appended claims will be readily apparent to those skilled in the art.

What is claimed is:

1. A method comprising:
obtaining an asset balance structure, wherein the asset balance structure specifies asset balances, as of a given point in time, for a set of blockchain addresses associated with a blockchain system comprising blocks that reflect transactions associated with the assets;
obtaining one or more transactions associated with the assets for any of the set of blockchain addresses that occur after generation of the asset balance structure; and
applying the one or more transactions associated with the assets that occur after generation of the asset balance structure to the asset balance structure to generate an updated indication of the asset balances for the set of blockchain addresses;
wherein the steps are performed by at least one processing device comprising a processor and a memory.

2. The method of claim 1, wherein the set of blockchain addresses correspond to asset wallets of users of the blockchain system.

3. The method of claim 2, wherein a given asset wallet stores the asset balance structure rather than the entire set of blocks of the blockchain system.

4. The method of claim 1, wherein the asset balance structure, when generated, comprises one or more outputs of transactions that do not serve as one or more inputs to any subsequent transactions.

5. The method of claim 1, wherein the asset balance structure is stored as a snapshot.

6. The method of claim 1, wherein the asset balance structure is stored external to the blockchain system.

7. The method of claim 6, wherein the step of obtaining the asset balance structure further comprises downloading the asset balance structure from a storage system external to the blockchain system.

8. The method of claim 7, wherein the storage system external to the blockchain system comprises a cloud computing platform.

9. The method of claim 6, wherein a digital signature associated with the asset balance structure is stored on the blockchain system.

10. The method of claim 9, wherein the digital signature is used to verify the content of the asset balance structure.

11. The method of claim 1, wherein the asset balance structure is initially generated at the given point in time from the historical blocks of the blockchain system.

12. The method of claim 11, wherein the asset balance structure is periodically generated.

13. The method of claim 1, wherein the assets within the blockchain system comprise units of cryptocurrency.

14. The method of claim 13, wherein the units of cryptocurrency comprise bitcoin units.

15. An article of manufacture comprising a non-transitory processor-readable storage medium having stored therein program code of one or more software programs, wherein the program code when executed by at least one processing device causes the processing device to perform steps of:
obtaining an asset balance structure, wherein the asset balance structure specifies asset balances, as of a given point in time, for a set of blockchain addresses associated with a blockchain system comprising blocks that reflect transactions associated with the assets;
obtaining one or more transactions associated with the assets for any of the set of blockchain addresses that occur after generation of the asset balance structure; and
applying the one or more transactions associated with the assets that occur after generation of the asset balance structure to the asset balance structure to generate an updated indication of the asset balances for the set of blockchain addresses.

16. An apparatus comprising at least one processing device, wherein the at least one processing device comprises a processor coupled to a memory as part of a node of a blockchain system, the node configured to:
obtain an asset balance structure, wherein the asset balance structure specifies asset balances, as of a given point in time, for a set of blockchain addresses associated with the blockchain system comprising blocks that reflect transactions associated with the assets;
obtain one or more transactions associated with the assets for any of the set of blockchain addresses that occur after generation of the asset balance structure; and
apply the one or more transactions associated with the assets that occur after generation of the asset balance structure to the asset balance structure to generate an updated indication of the asset balances for the set of blockchain addresses.

17. The apparatus of claim 16, wherein the set of blockchain addresses correspond to asset wallets of users of the blockchain system.

18. The apparatus of claim 17, wherein a given asset wallet stores the asset balance structure rather than the entire set of blocks of the blockchain system.

19. The apparatus of claim 16, wherein the asset balance structure, when generated, comprises one or more outputs of transactions that do not serve as one or more inputs to any subsequent transactions.

20. The apparatus of claim 16, wherein the asset balance structure is stored as a snapshot.
